(19) United States
(12) Patent Application Publication
(10) Pub. No.: US 2014/0345704 A1
(43) Pub. Date: Nov. 27, 2014

(54) GAS VALVE WITH MULTI-FUEL CAPABILITY

(71) Applicant: W.C. BRADLEY CO., Columbus, GA (US)

(72) Inventor: ANDREW WOLF KAHLER, Fortson, GA (US)

(73) Assignee: W.C. BRADLEY CO., Columbus, GA (US)

(21) Appl. No.: 14/284,603

(22) Filed: May 22, 2014

Related U.S. Application Data
(60) Provisional application No. 61/826,355, filed on May 22, 2013.

(51) Int. Cl. F16K 5/02

(52) U.S. Cl. CPC F16K 5/0207; F16K 5/0292
USPC 137/15.24; 251/309

(57) ABSTRACT

A dual flow gas valve suitable for gas grills that allows a user to select the valve for use with gases of different heating values and to select one of a high flow position and a low flow position for each gas. The gas valve includes a body and an input passageway communicating with the body. In one embodiment, a rotational member in the body defines a first port communicating the input passageway with an interior chamber. The rotational member defines an additional passageway external to the rotational member. The rotational member may be rotated to a first position to activate high flow through the rotational member or may be rotated to a second position to activate the external, low flow, passageway.

### CROSS REFERENCE TO RELATED APPLICATIONS

This application claims the priority of U.S. Provisional Patent Application No. 61/826,355 entitled “GAS VALVE WITH MULTI-FUEL CAPABILITY,” filed May 22, 2013, the contents of which are hereby incorporated by reference.

### FIELD OF THE INVENTION

The invention relates to a gas valve that may be easily modified to regulate gases having different heating values per unit volume.

### BACKGROUND OF THE INVENTION

The problem of how to address the use of multiple gas fuels on gas grills and similar cooking appliances has been addressed in a number of ways over the years. One problem is that two gases, such as propane and natural gas, have very different heating values per unit volume, i.e., propane has a heat value of around 2500 BTU/cubic foot and natural gas around 1000 BTU/cubic foot. It is desirable to avoid requiring two different valves, i.e., to use a single valve that may be modified to allow conversion from a low heating value gas requiring high volumetric flow to a high heating value gas requiring lower volumetric flow. A typical valve used for this application has a solid cone with an internal passage that is rotated inside a cast or forged body to align openings in the plug with openings in the side and end of the body to enable gas to flow at various volumetric flow rates.

An early approach is outlined in Carlson, U.S. Pat. No. 4,020,870, in which the volume flow differential at high BTU/hr rates is handled by a change in the final orifice affixed to the exit end of the valve body and the volume rate differential at lower BTU/hr rates is handled by a screw coaxial with the cone that is advanced or retreated to block or open one of a pair of small holes used to meter flow. For high heating value gas the screw is set to have only one pair of holes open and for the low heating value gas the set screw is set to have both pairs of holes open.

A further approach is outlined in Massey, U.S. Pat. No. 5,009,393, in which the volume flow differential for different gases at low BTU/hr rates is handled by an externally adjustable sleeve inside the rotating cone that opens or closes an additional low flow orifice, opening it for the low heating value gas and closing it for the low heating value gas. This sleeve is adjusted by a rotation driven by a tool inserted down a tubular valve stem as in the previously mentioned art.

In Zhang, U.S. Pat. No. 7,458,386, this concept is taken further as the adjustable sleeve inside the rotating cone is used to change the low BTU/hr rates for the different gases and a new design of externally adjustable final orifice is used to change the high BTU/hr rate for the different gases.

It should be understood that in all three cases above, two reconfigurations are required, one at the final orifice where it typically inserts into the burner, and one by adjustment with a tool inserted down the valve stem from the exterior of the appliance.

A different approach is taken in Parrish, US Patent Application Publication No. 2008/0289615. A coaxial dual stage final orifice is constructed with the outer stage feed by a bypass on one side of the valve cone combined with a normal port feeding the inner stage. On the other side of the cone is a normal port that only feeds the inner stage. For high heating value gas, the side of the cone is used that feeds only the inner stage and for low heating value gas the side of the cone is used that feeds both the inner and outer stages. A limitation means is devised to allow reconfiguration of the valve to utilize either of the two sides of the cone, depending on the gas used. It will be appreciated that the intent of this design to be able to make the change over with only one reconfiguration which can in principle be done from the exterior of the appliance.

In Hsiao, US Patent Application Publication No. 2009/0235988, the cone has two sets of large (high flow) and small (low flow) holes oppositely arranged with one set having a bypass hole provided that creates additional flow to a secondary final orifice placed alongside the normally configured final orifice, which is coaxial with the valve cone. For high heating value gas, the valve cone is rotated to engage the flow control holes that do not have the bypass hole located to cooperate with the flow control holes. For low heating value gas, the added flow required is obtained by rotating the cone to engage the flow control holes that have a bypass hole located to cooperate with them. At high flow rates the difference in flow is established by the addition of the bypass. At low flow rates it appears that the difference in flow is established by different sizing of the low flow holes.

The approach taken by Albizuri in U.S. Pat. Nos. 7,156,370, 7,641,470, 7,651,330, 7,950,834, 7,963,763, 7,967,005, and 8,092,212, is substantially different as the difference in flow rate for different gas at low flow rates is accomplished by two low flow holes accessed by turning the valve cone to two successive positions, the first accessing a low flow hole of relatively larger size for the lower heating value gas and the second accessing a low flow hole of relatively smaller size for the higher heating value gas, with various means defined to limit or define the valve cone rotation. The flow rate differential at the high flow condition is accomplished either by change of a removable final orifice or by the use of two orifices in series, when the larger sized orifice is placed interiorly relative to the smaller sized orifice such that when the smaller sized orifice, matched to the higher heating value gas, is removed the larger sized orifice, matched to the lower heating value gas, is exposed and functional. It would be understood that in this approach it is required to reconfigure the valve cone rotation definition and reconfigure the final orifice to achieve the desired conversion of gas type.

Carvalho, in US Patent Application Publication No. 2013/0000624, defines another means of achieving the limitation of valve cone rotation described by Albizuri.

May, in US Patent Application Publication No. 2011/0030501, likewise defines another means of achieving the limitation of valve cone rotation described by Albizuri.

It should be evident that there are significant limitations in the prior art, taken individually and in groups. For example, Carlson, Massey, Zhang, Albizuri, Carvalho, and May all require two reconfigurations to be carried out to convert from one gas to another. In the case of Parrish, which only requires a single reconfiguration, the operation from OFF to HIGH to LOW flow is carried out in opposite rotational direction for the two different gas types, which may be confusing to the consumer and may violate product safety certification rules. In the case of Hsiao, which only requires a single reconfiguration, the double outlet in the low heating value gas case significantly complicates the design of the mating burner, which should ideally function for both gas types. Other disadvantages, such as manufacturing complexity, difficulty in determining which gas the valve is set for from external visual inspection, and difficulty in obtaining a linear change in flow from high rate to low rate present themselves in various of the prior art designs.

### SUMMARY OF THE INVENTION

The proposed valve of the invention has a rotating cone inside a body with ports in a plug. The valve has a body, wherein the ports in the plug and in the body are rotationally aligned to produce various flow rates. In the inventive valve, the final orifice used to regulate flow in the high flow case can be made in two different configurations in which a member extends into the body and further into the inside of the rotating cone. A seal is used to route flow though a bypass and orifice that is correctly sized for a low flow rate of different types of gas.

As will be seen from the detailed description and specification there are several advantages of this device over prior the art. First, only one reconfiguration is required to convert from one type of gas to another since the orifice change will change both the low flow and high flow rates of the valve. Second, the valve rotation and arc of actuation will be entirely unchanged for two different gas types, which is not the case with the prior art designs that allow for single reconfiguration. Third, manufacture of the new inventive valve is possible with very straightforward techniques that will not pose a challenge to any manufacturer of such devices. For example, the final assembly of this valve consists of the same number of parts assembled in the same sequence as a standard non-convertible valve.

### BRIEF DESCRIPTION OF THE DRAWINGS

FIG. 1 is an exploded view of the gas valve of the invention;

FIG. 2A is an enlarged perspective view of a tapered end of the rotatable conical insert in the gas valve shown in FIG. 1;

FIG. 2B is an enlarged perspective view of a stepped end of the rotatable conical insert in the gas valve shown in FIG. 1;

FIG. 3 is a cross-sectional assembled view of the gas valve of FIG. 1 shown in an OFF position;

FIG. 4 is a cross-sectional perspective assembled view of the gas valve of FIG. 1 shown in a HIGH FLOW position;

FIG. 5 is a cross-sectional perspective assembled view of the gas valve of FIG. 1 shown in a LOW FLOW position;

FIG. 6 is a cross-sectional perspective assembled view of the gas valve of FIG. 1 shown in a MEDIUM FLOW position;

FIG. 7 is a cross-sectional perspective assembled view of the gas valve of FIG. 1 shown from a perspective approximately aligned with a gas input passageway;

FIG. 8A shows an alternate embodiment of the gas valve of FIG. 1, wherein a longitudinal slot is formed in the valve body rather than in the conical insert, wherein the gas valve is shown in an OFF position;

FIG. 8B shows the gas valve of FIG. 8A, wherein the gas valve is shown in a HIGH FLOW position;

FIG. 8C shows the gas valve of FIG. 8B, wherein the gas valve is shown in a LOW FLOW position;

FIG. 8D shows an enlarged perspective view of a second embodiment of the rotatable conical insert of the gas valve of FIGS. 8A-8C having an extension protruding from a tapered end;

FIG. 9A is an alternate embodiment of the gas valve of FIG. 1 wherein the conical insert is provided with a first hole and a second hole for selecting between flow conditions, wherein the gas valve is positioned in an OFF position;

FIG. 9B is an alternate embodiment of the gas valve of FIG. 9A, wherein the gas valve is positioned in a HIGH FLOW position;

FIG. 9C is an alternate embodiment of the gas valve of FIG. 9A, wherein the gas valve is positioned in a LOW FLOW position;

FIG. 10A shows a perspective view of an exit end of an alternate embodiment of the gas valve of FIG. 1, wherein the orifice member is configured with alternate locations for a low flow orifice and a low flow bypass;

FIG. 10B shows a perspective view of a plug end of an alternate embodiment of the gas valve of FIG. 1, wherein the orifice member is configured with alternate locations for a low flow orifice and a low flow bypass;

FIG. 11 is an alternate embodiment of the gas valve of FIG. 1 wherein the orifice member has an alternate configuration with respect to threads and the sealing member;

FIG. 12 is an alternate embodiment of the gas valve of FIG. 1 wherein the orifice member is secured by an orifice cap.

### DETAILED DESCRIPTION OF THE PREFERRED EMBODIMENTS

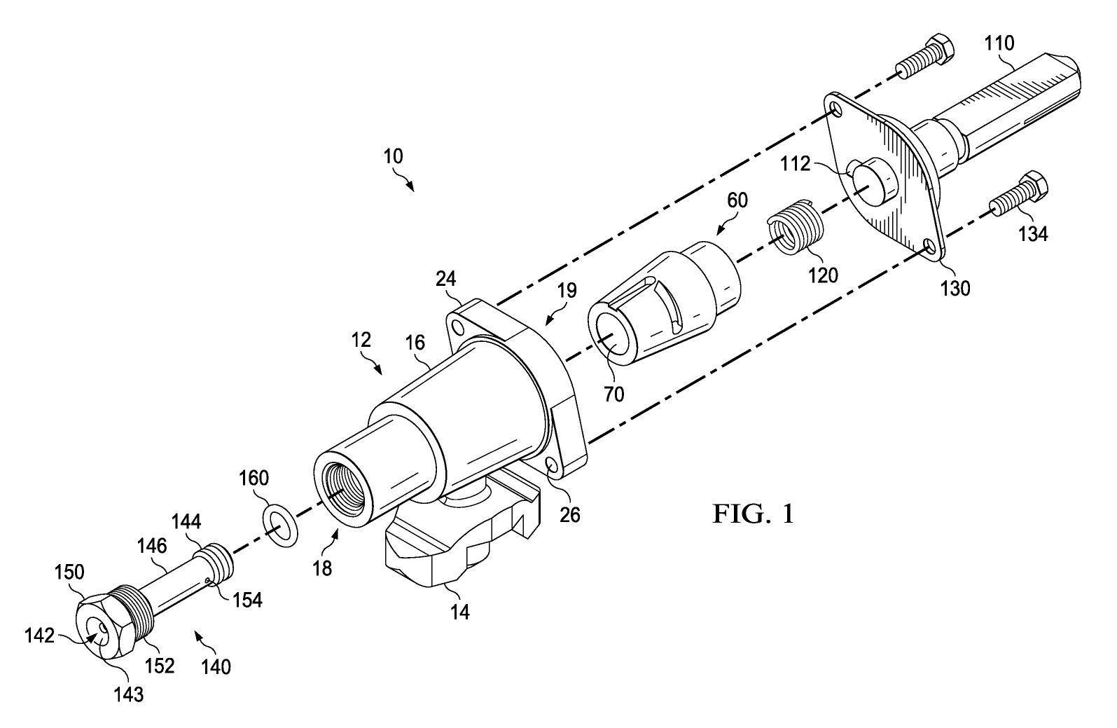

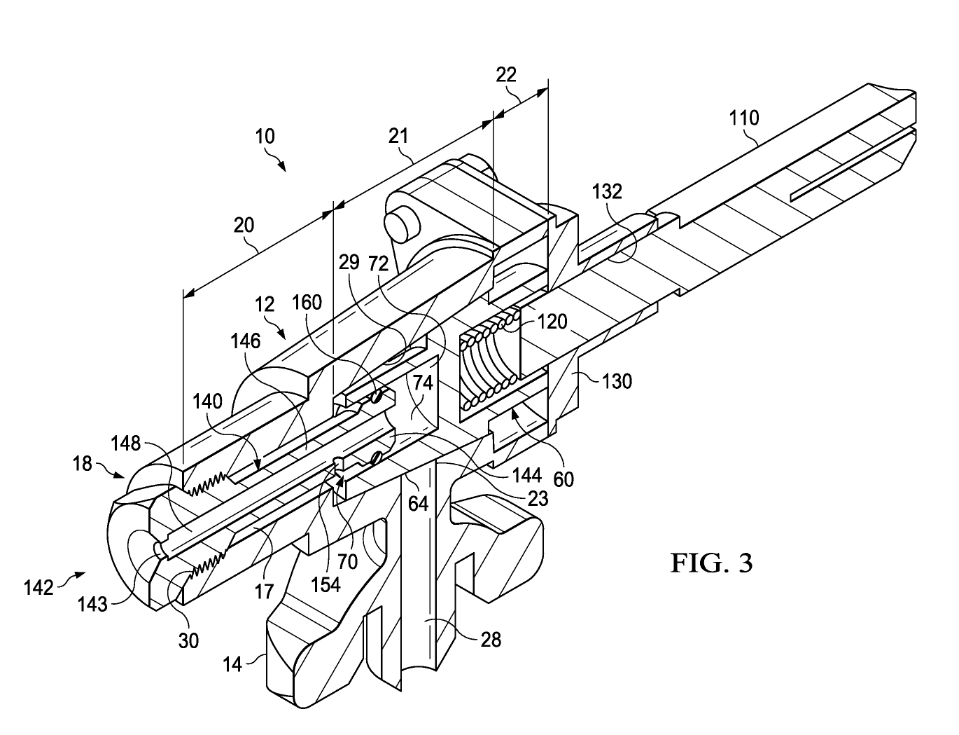

Referring now to FIGS. 1-7, shown is a gas valve 10 of the invention. Gas valve 10 includes valve body 12. Valve body 12 has a gas source connector portion 14 and a body portion 16. Body portion 16 defines primary passageway 17 having a threaded end 18 and a component end 19. Primary passageway 17 has an exit section 20, a tapered section 21, a component section 22, and an input orifice 23 (FIGS. 3-7). Component end 19 preferably defines flange 24. Flange 24 preferably defines a plurality of fastener orifices 26 (FIG. 1). Gas source connector portion 14 defines gas input passageway 28 (FIGS. 3-7) that communicates with tapered section 21 of primary passageway 17 through input orifice 23. Tapered section 21 defines internally tapered surface 29. Exit section 20 defines internal threads 30.

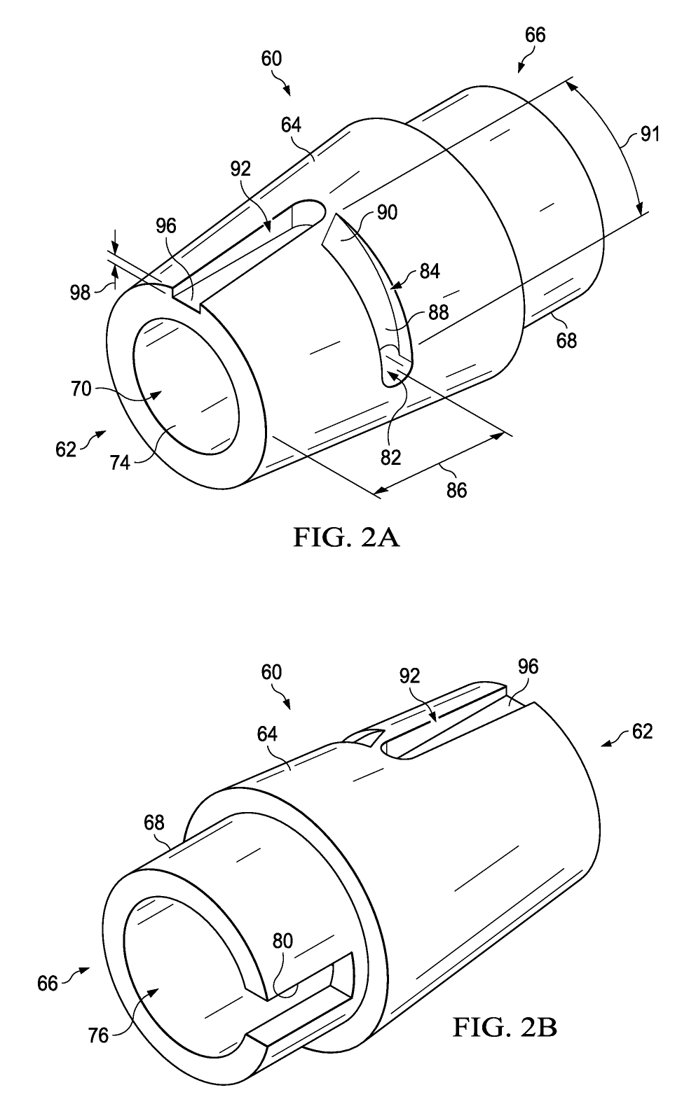

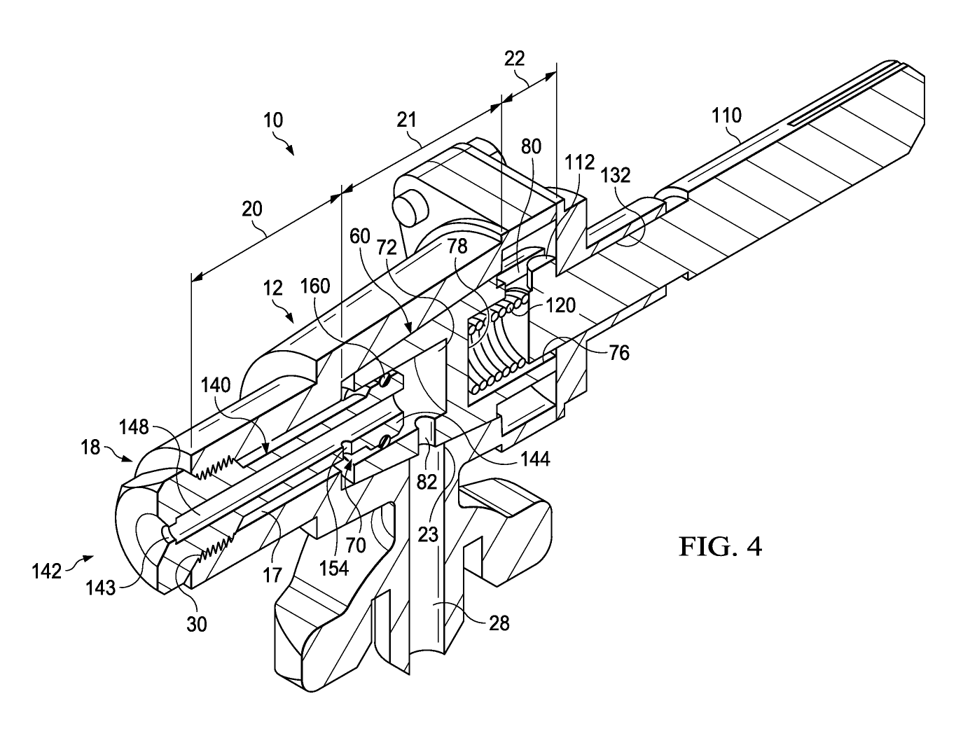

Rotatable conical insert 60 is received in component end 19 of valve body 12. As shown in an enlarged view in FIGS. 2A and 2B, conical insert 60 has a tapered end 62 having tapered outer surface 64. Conical insert 60 additionally has stepped end 66 defining stepped outer surface 68. Tapered outer surface 64 is matingly received within internally tapered surface 29 of tapered section 21 of primary passageway 17 (FIGS. 3-7). Conical insert 60 defines first blind hole 70 (FIG. 2A) defining first bottom surface 72 (FIGS. 3-7) and cylindrical surface 74. First blind hole 70 is defined on tapered end 62 of conical insert 60. Second blind hole 76 (FIGS. 2B, 4-6) defines second bottom surface 78. Second blind hole 76 is defined on stepped end 66 of conical insert 60. Second blind hole 76 additionally defines key slot 80 (FIGS. 2B, 4). Conical insert 60 defines high flow hole 82 that communicates tapered outer surface 64 with cylindrical surface 74 of first blind hole 70.

Referring now particularly to FIG. 2A, tapered outer surface 64 defines partial circumferential transition slot 84 that partially encircles conical insert 60 wherein an outer edge of slot 84 is a first distance 86 from tapered end 62 of conical insert 60. Transition slot 84 has a deep end 88 that is proximate to high flow hole 82. Transition slot 84 additionally has shallow end 90. Transition slot 84 decreases in depth from high flow hole 82 to shallow end 90. Shallow end 90 preferably terminates at a zero depth, i.e., terminates at tapered outer surface 64. The graded transition slot 84 defines a medium flow area 91. Conical insert 60 further defines longitudinal slot 92 that terminates at first distance 86 from tapered end 62 of conical insert 60. Longitudinal slot 92 has an exit end 96 that communicates with tapered end 62 of conical insert 60. Exit end 96 of longitudinal slot 92 has a first depth 98.

Referring back to FIGS. 1 and 3-7, shaft 110 is received within second blind hole 76 of conical insert 60. Shaft 110 is provided with key 112 (FIGS. 1, 4) for locating in key slot 80 of second blind hole 76 of conical insert 60. Key 112 is for facilitating rotation of conical insert 60 with shaft 110. Spring 120 is received in second blind hole 76 of conical insert 60. Spring 120 is located between second bottom surface 78 of second blind hole 76 and shaft 110 for urging tapered outer surface 64 of conical insert 60 into sealing contact with internally tapered surface 29 of valve body insert 12. Spring 120 additionally facilitates a press-to-turn feature when a user attempts to rotate shaft 110. Spring 120 presses shaft 110 outwardly, which results in key 112 being pressed against an inner surface of cover plate 130. In a preferred embodiment, inner surface of cover plate 130 is provided with detents so that shaft 110 must be pressed inwardly against the force of spring 120 to release key 112 to allow rotation of shaft 110. Lesser detents are preferably provided on inner surface of cover plate 130 around shaft 110 to provided tactile feedback as shaft 110 is rotated and as key 112 passes over inner surface of cover plate 130. The lesser detents may be positioned to alert a user when one of low, medium and high flow positions are achieved. Other detent positions may also be provided.

Cover plate 130 defines shaft orifice 132 for receiving shaft 110. Cover plate 130 is affixed to flange 24 on component end 19 of valve body 12 with fasteners 134 received within fastener orifices 26 of flange 24.

Orifice member 140 has an exit end 142 defining an exit orifice 143 and a plug end 144 connected together with an extension portion 146. Orifice member 140 defines interior passageway 148 (see, e.g., FIGS. 3 and 4) that passes through extension portion 146 and communicates exit end 142 with plug end 144. Exit end 142 defines exit portion 150 adjacent to threaded portion 152. Threaded portion 152 is provided for threaded engagement with internal threads 30 of exit section 20 of valve body 12. Plug end 144 is received within first blind hole 70 of conical insert 60. Extension portion 146 further defines low flow orifice 154 (FIGS. 1 and 3-7) that communicates interior passageway 148 with an exterior surface of extension portion 146.

Sealing member 160, such as an O-ring, is received on plug end 144 of orifice member 140 for sealingly engaging cylindrical surface 74 of first blind hole 70 of conical insert 60.

In FIG. 1, shown is an exploded view of gas valve 10 the invention. Valve body 12 has a gas source connection portion 14 to allow connection to a gas source such as a gas tube manifold of typical sort. Conical insert 60, that rotates inside valve body 12, is held into place and is rotated by a typical valve stem assembly that includes spring 120 and a rotatable and axially movable shaft 110 with a key 112 for transmitting rotation to the conical insert 60. In addition, fasteners 134 are shown that are received in fastener orifices 26 of valve body 12 to hold the valve stem assembly in place. Orifice member 140 is shown disassembled, attaching to valve body 12 with threaded portion 152. Orifice member 140 is shown with extension portion 146 and a plug end 144, for mounting sealing member 160, such as an O-ring. Orifice member 140 also has an exit portion 150 that is configured to allow rotation of orifice member 140 and contains exterior orifice 143 for gas flow into a burner.

Rotatable conical insert 60 is shown in more detail in FIG. 2 where critical design features are shown in greater detail. It will be readily understood with reference to FIGS. 3-7 that the conical insert 60 defines first blind hole 70, which forms part of a gas pathway leading to the output, i.e., to exit orifice 143 of gas valve 10. Arranged around the circumference of the conical insert 60 is first a high flow hole 82, which admits gas into first blind hole 70 when high flow hole 82 is aligned with input orifice 23 of gas input passageway 28. Next there is a transition slot 84 cut into the circumference of conical insert 60, which reduces the flow of gas into first blind hole 70 as conical insert 60 is rotated so that high flow hole 82 no longer aligns directly with input orifice 23. In this configuration, gas flows through gas input passageway 28, through input orifice 23, and enters transition slot 84, whereupon the gas flows to the high flow hole 82. However, flow is reduced due to the progressive reduction in area in transition slot 84. Longitudinal slot 92 extends downward along the outside surface of conical insert 60. The function of longitudinal slot 92 will become clear as we describe the operating modes of gas valve 10 are described as follows.

In FIG. 3, we show a section of gas valve 10 in the OFF position. In this case, gas input passageway 28 in valve body 12 is aligned with a section of tapered outer surface 64 of conical insert 60 that has no opening. In this case, no gas can flow in any path to the exit orifice 143. It will be noted in this assembly view that the plug end 144 on extension portion 146 of orifice member 140 extends into first blind hole 70 of conical insert 60 and that the sealing member 160 forms a sealing surface with respect to the inside diameter or cylindrical surface 74 of first blind hole 70.

In FIG. 4, we show a section of gas valve 10 in the HIGH position. We see the effect of rotating conical insert 60 so that high flow hole 82 is aligned with input orifice 23 of gas input passageway 28 of valve body 10. In this case, gas flows through gas input passageway 28, through input orifice 23, and through high flow hole 82 into an interior space defined by first bottom surface 72 of first blind hole 70 and sealing member 160 on plug end 144 of orifice member 140. From there the gas flows down interior passageway 148 of orifice member 140 and then flows through exit orifice 143 defined to produce the maximum flow rate for that type of gas.

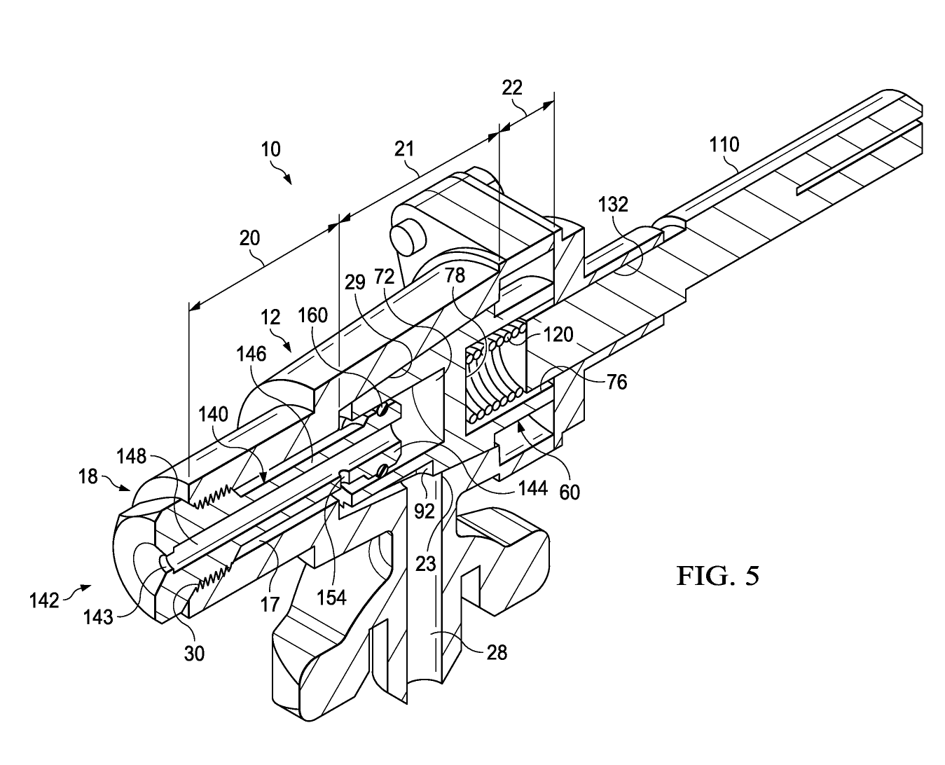

In FIG. 5, we show a section of gas valve 10 in the LOW position. We see the effect of rotating conical insert 60 so that input orifice 23 of gas input passageway 28 is aligned with longitudinal slot 92 so that the gas is traveling through longitudinal slot 92 to an annular space defined by an outer diameter of extension portion 146 of orifice member 140 and the corresponding coaxial inner diameter of portion of exit section 20 of primary passageway 17. The gas then flows through the low flow orifice 154 in the side of the extension portion 146 into the interior passageway 148 of the orifice member 140 and then out through the exit orifice 143 with flow rate defined by the area of the low flow orifice 154.

By inspection of FIG. 2, and with reference to FIGS. 3-7, it will be seen that in an intermediate position of conical insert 60, which we might call the MEDIUM position of the valve, it will be possible for input orifice 23 of gas input passageway 28 to align at a place along transition slot 84 so that all the gas travels along transition slot 84 through high flow hole 82 into the interior space defined by first bottom surface 72 of first blind hole 70 and sealing member 160 on plug end 144 as previously described.

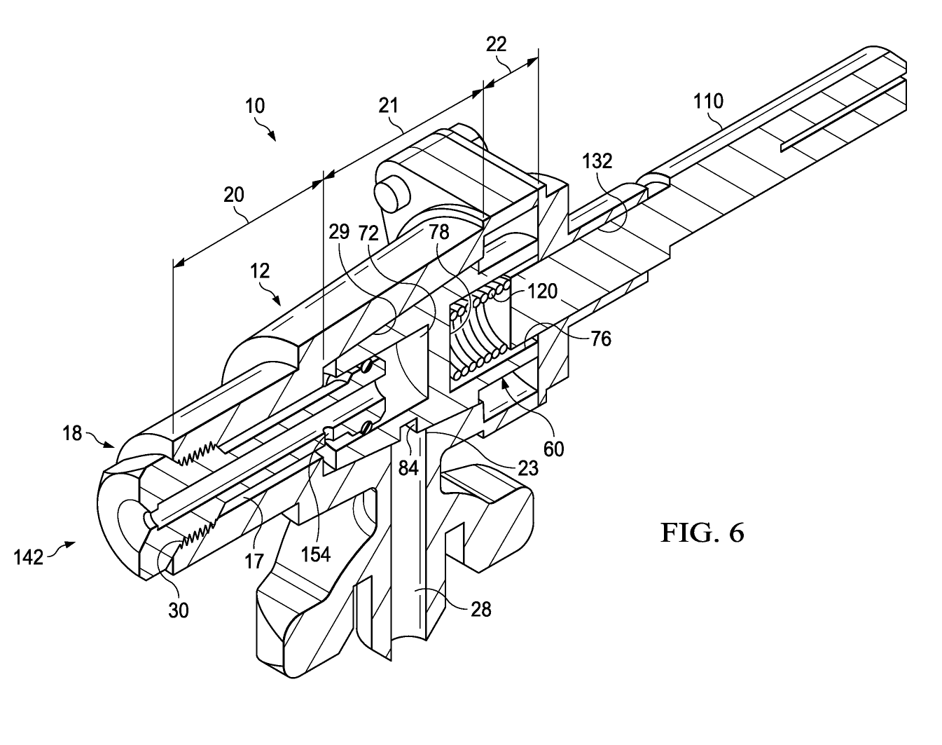

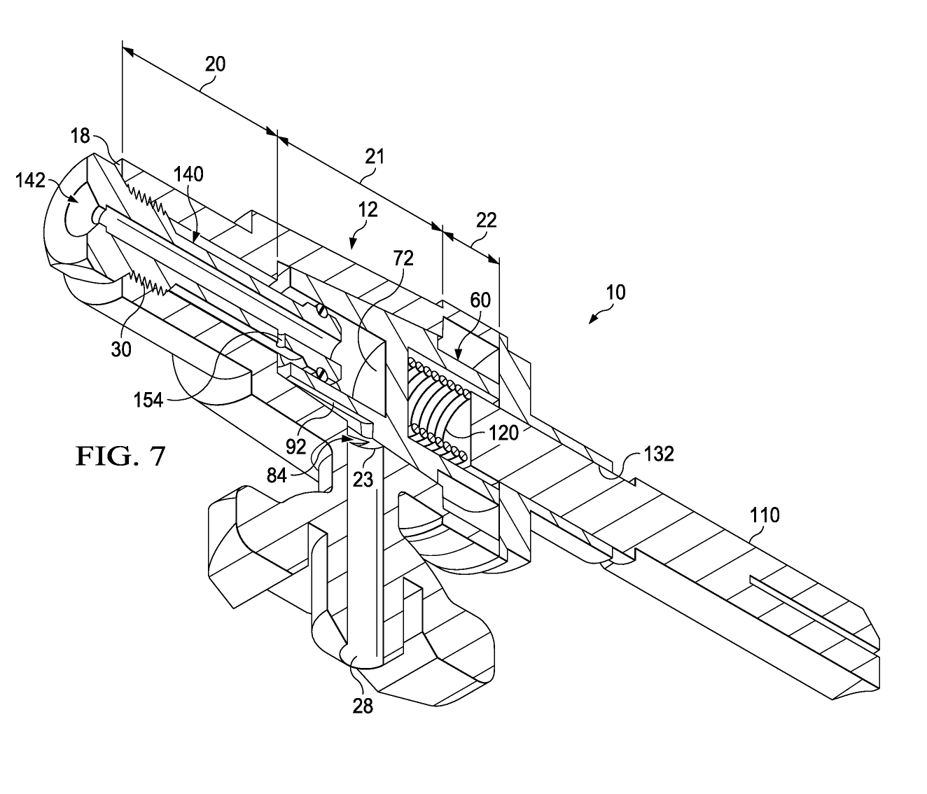

It also can be seen in FIGS. 6 and 7, which depict gas valve 10 at slightly different rotations, that it might be possible to design gas valve 10 so that there is a position in which input orifice 23 of gas input passageway 28 might be partially aligned with transition slot 84 (best seen in FIG. 7) and partially aligned with longitudinal slot 92 so that gas flow is split along the two paths described above with regard to the MEDIUM and LOW positions, providing a further ability to design the flow rate as a function of rotation of conical insert 60 to change as smoothly as possible from HIGH to MEDIUM to LOW. This is further illustrated in FIG. 7 where we look through a sectioned view of gas valve 10 along gas input passageway 28 and see part of the transition slot 84 exposed as well as part of longitudinal slot 92.

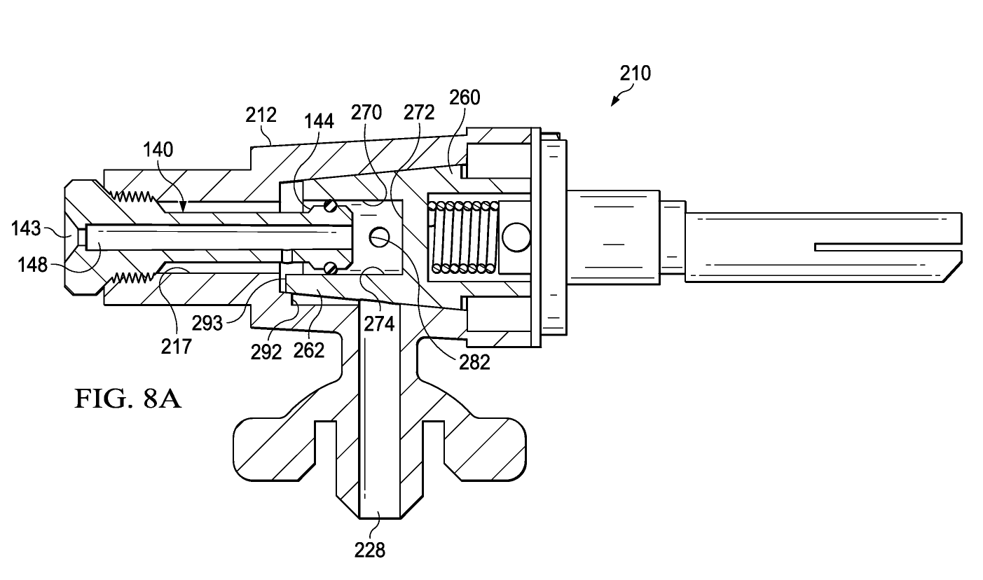

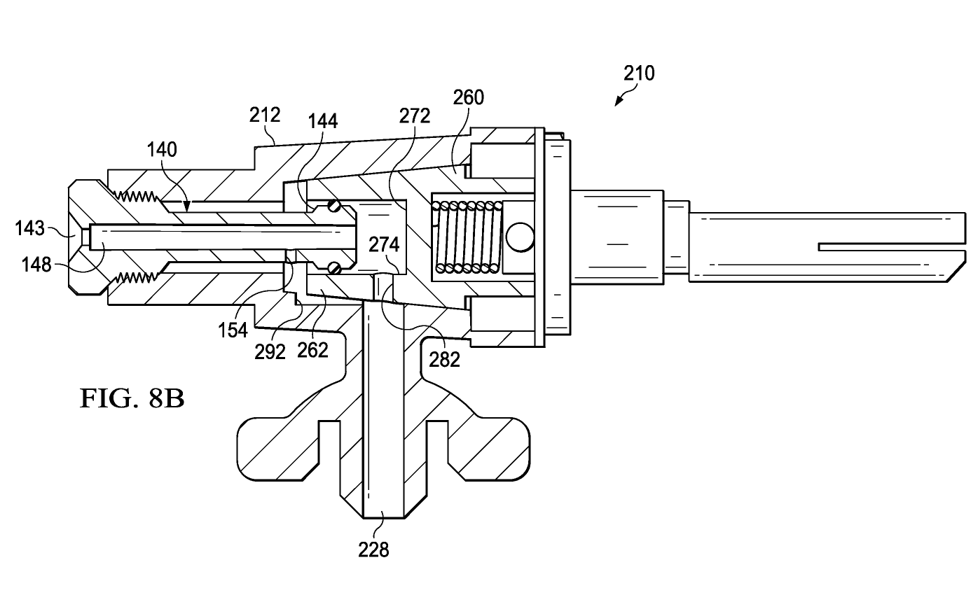

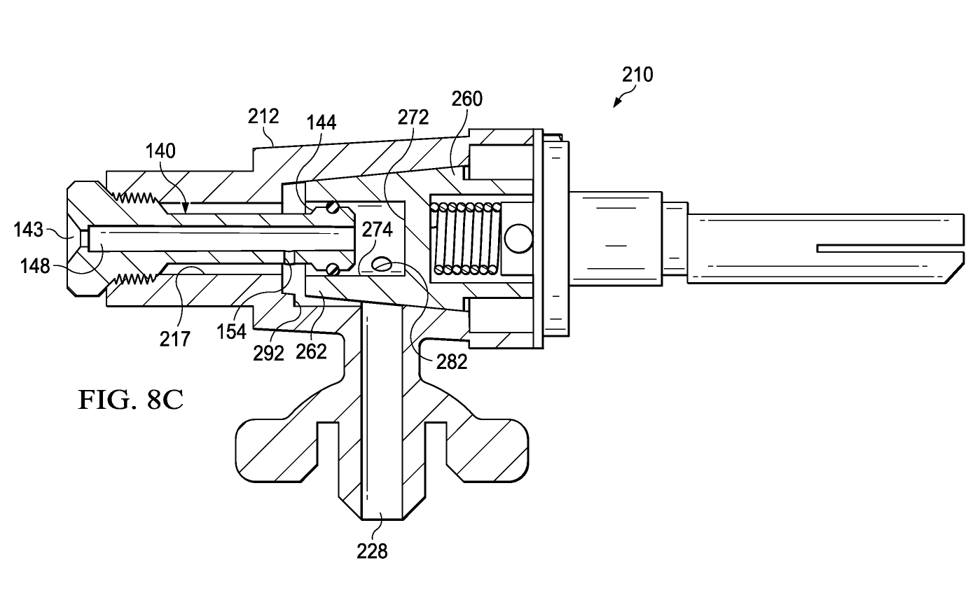

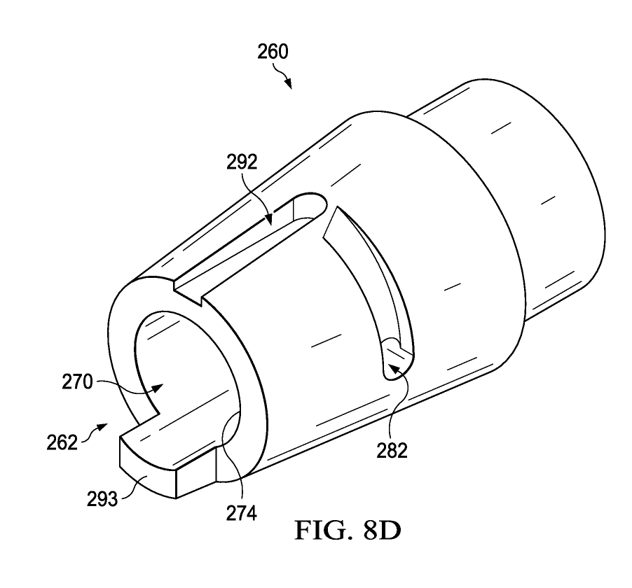

In one alternate embodiment, longitudinal slot 92 is relocated from conical insert 60 to valve body 12. Longitudinal slot 92 may further be formed by a combination of features found on conical insert 60 and on valve body 12. Referring now to FIGS. 8A-8D, alternate gas valve 210 is shown in an OFF (FIG. 8A), HIGH FLOW (FIG. 8B), and LOW FLOW (FIG. 8C) position. In FIG. 8A, it can be seen that valve body slot 292, formed in valve body 212, is blocked from communication with gas input passageway 228 by extension 293 on tapered end 262 of conical insert 260. Additionally, gas input passageway 228 is blocked from communicating with an interior space defined by plug end 144 of orifice member 140, and first blind hole 270, i.e., by first bottom surface 272 and cylindrical surface 274. Therefore, valve 210 is an “OFF” position, since no gas can flow into interior passageway 148 and out of exit orifice 143 of orifice member 140.

FIG. 8B shows alternate gas valve 210 in a HIGH FLOW configuration, wherein conical insert 260 is rotated so that high flow hole 282 communicates with gas input passageway 228. Gas is, therefore, able to flow through gas input passageway 228, through high flow hole 282 and into plug end 144 of orifice member 140 before passing through interior passageway 148 and out exit orifice 143. Gas may also be able to flow through low flow orifice 154 in the same manner as explained with regard to FIG. 8C.

FIG. 8C shows alternate gas valve 210 in a LOW FLOW configuration, wherein conical insert 260 is rotated so that gas is able to pass through valve body slot 292 and into primary passageway 217 and low flow orifice 154 and through interior passageway 148 where the gas exits through exit orifice 143 of orifice member 140. Gas input passageway 228 is blocked from communicating with an interior space defined by plug end 144 of orifice member 140, and first bottom surface 272 and cylindrical surface 274. Therefore, all flow passing through exit orifice 143 must pass through low flow orifice 154.

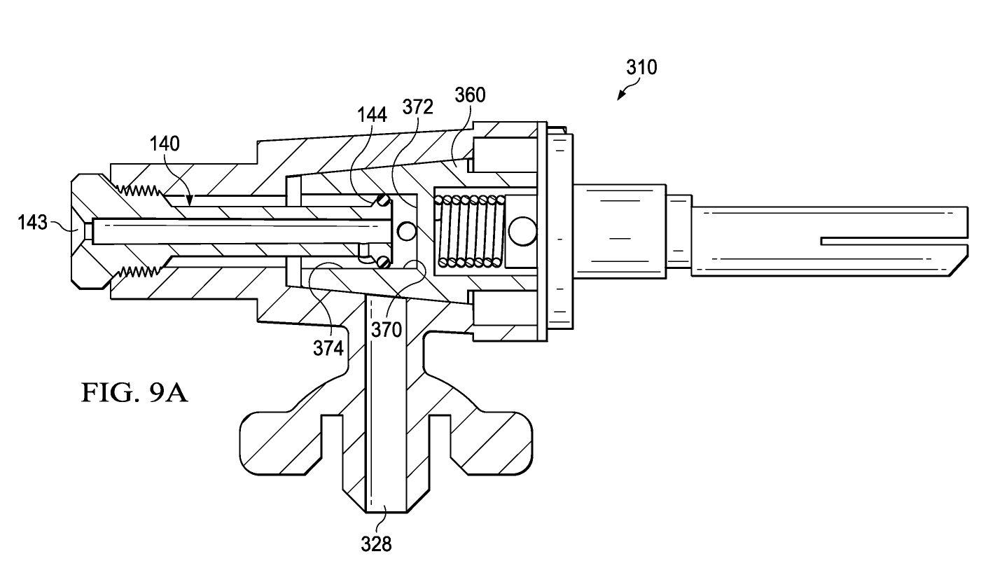

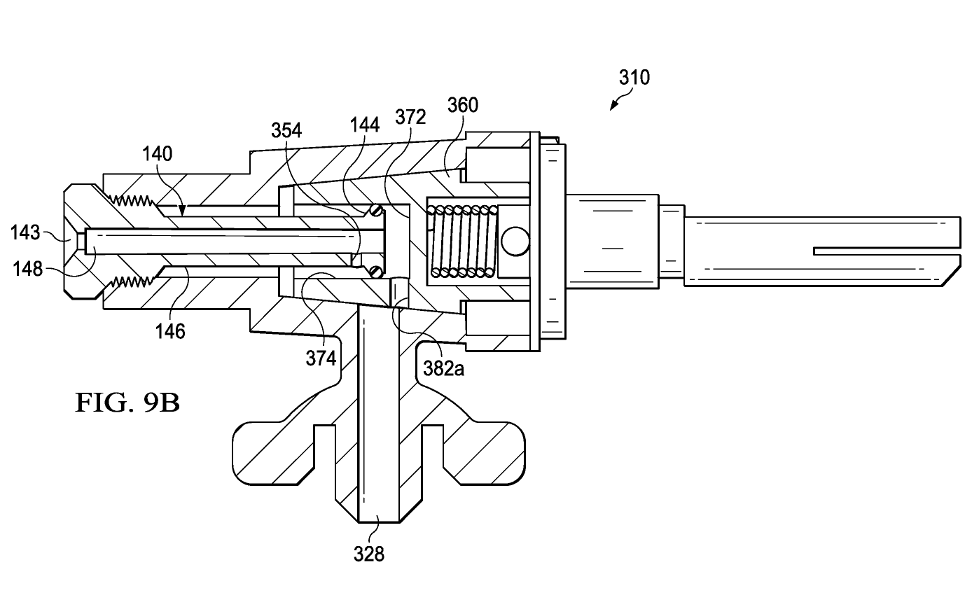

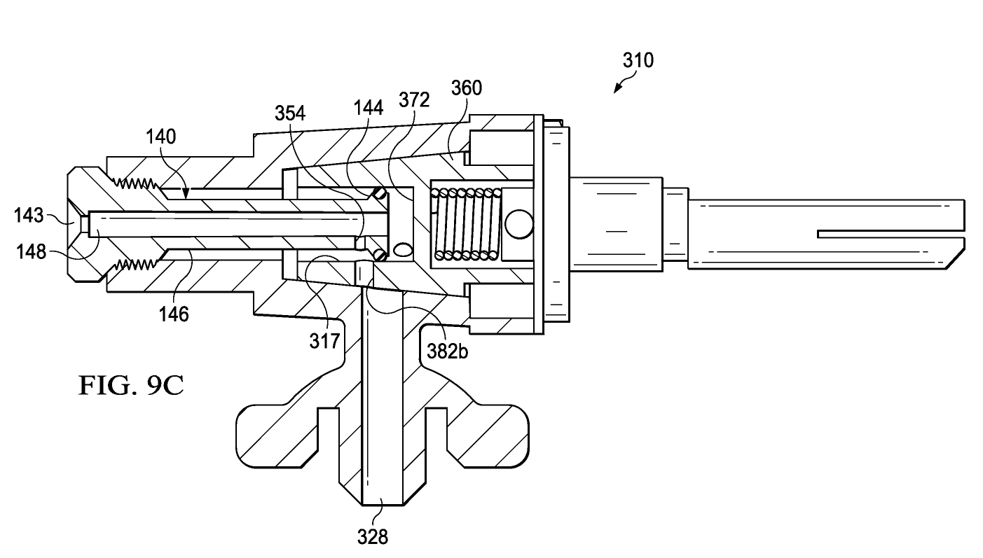

In an additional alternate embodiment, conical insert 60 may be replaced with conical insert 360 having a first flow hole 382a (FIG. 9B) and a second flow hole 382b (FIG. 9C) rather than a single high flow hole 82 (FIGS. 2 and 4) as discussed in the embodiment of FIGS. 1-7. Referring now to FIGS. 9A-9C, alternate gas valve 310 is shown in an OFF (FIG. 9A), HIGH FLOW (FIG. 9B), and LOW FLOW (FIG. 9C) position. In FIG. 9A, it can be seen that conical insert 360 is positioned such that no communication exists between gas input passageway 328 and an interior space defined by plug end 144 of orifice member 140, and first blind hole 370, i.e., first bottom surface 372 and cylindrical surface 374. Gas flow is, therefore, blocked from passing through orifice member 140 and exit orifice 143.

FIG. 9B shows alternate gas valve 310 in a HIGH FLOW configuration, wherein conical insert 360 is rotated so that a first flow hole 382a (FIG. 9B) communicates gas input passageway 328 with an interior space defined by plug end 144 of orifice member 140, and first bottom surface 372 and cylindrical surface 374. Gas is, therefore, directed through first flow hole 382a, into interior passageway 148 and out exit orifice 143.

FIG. 9C shows alternate gas valve 310 in a LOW FLOW configuration, wherein conical insert 360 is rotated so that a second flow hole 382b communicates gas input passageway 328 and an annular space defined by an inside of primary passageway 317 and an outside of extension portion 146 of orifice member 140. Gas is, therefore, directed through low flow orifice 354, into interior passageway 148 and out exit orifice 143.

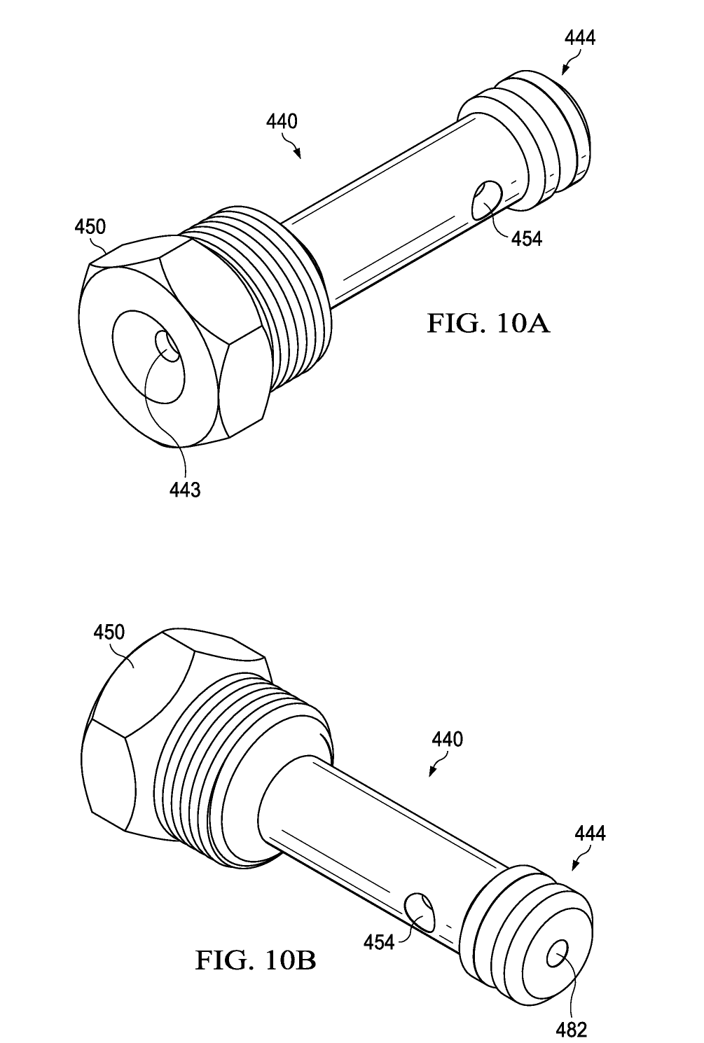

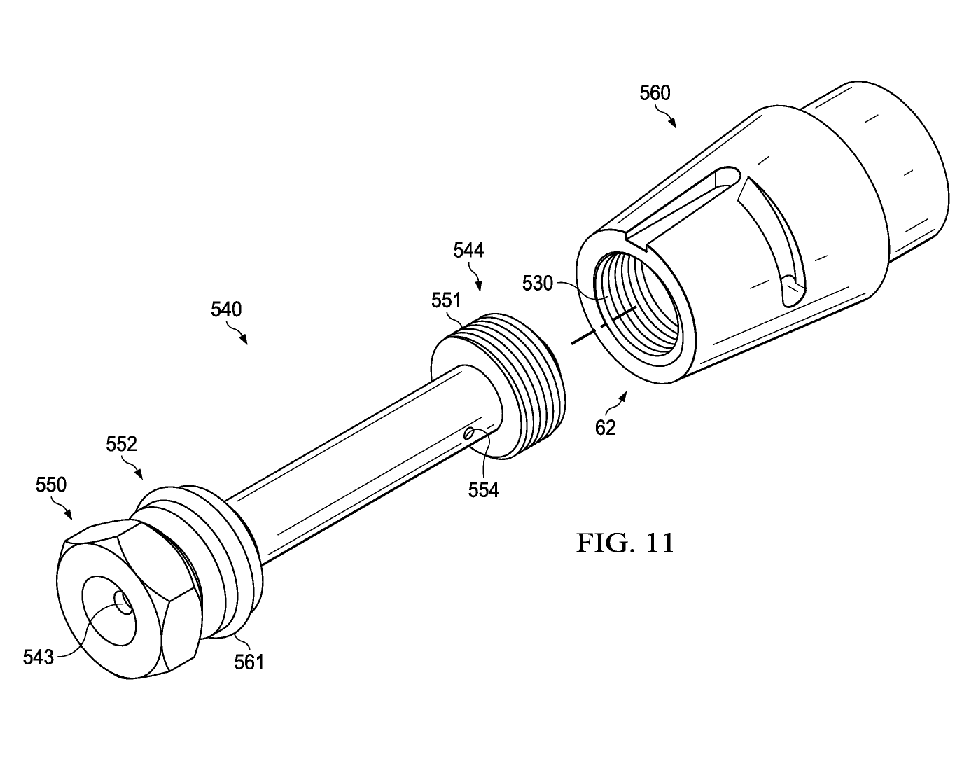

In a further embodiment, as shown in FIG. 10, low flow orifice 154 may be replaced with bypass orifice 454 and relocated to plug end 444 of orifice member 440 as low flow orifice 482. High flow or bypass orifice 454 is located on a longitudinal wall of orifice member 440 between plug end 444 and exit portion 450. Therefore, to achieve HIGH FLOW, the positioning of conical insert 60, when using orifice member 440 is the reverse of the position of conical insert 60 in the embodiment shown in FIGS. 1-7, i.e., is the LOW FLOW position of conical insert 60 of FIGS. 1-7. Similarly, to achieve LOW FLOW, the positioning of the conical insert 60, when used with orifice member 440, is the reverse of the position of conical member 60 in the embodiment shown in FIGS. 1-7, i.e., is the HIGH FLOW position of conical member 60 when used with the embodiment of FIGS. 1-7.

In a further embodiment, internal threads 30 of valve body 12 are relocated to an inside surface of tapered end 62 of conical insert 60. Referring now to FIG. 11, shown is an alternate embodiment wherein orifice member 540 has a plug end 544 provided with threads 551 for engaging internal threads 530 of conical insert 560. Sealing member 561, such as an O-ring, is located on sealing portion 552, adjacent to exit portion 550. Exit orifice 543 is defined by exit portion 550. Low flow orifice 554 is defined by a longitudinal wall of orifice member 540 between exit portion 550 and plug end 544.

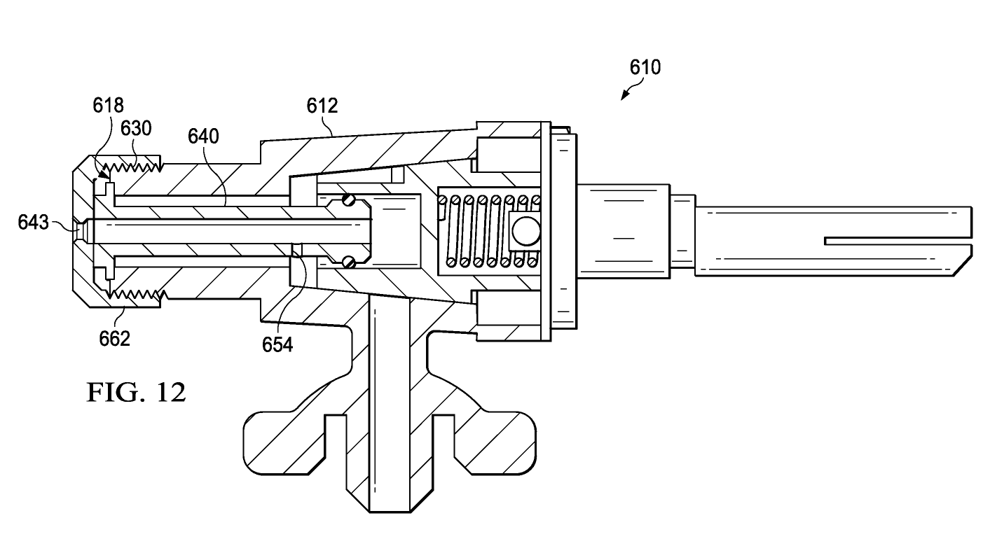

In an additional embodiment, i.e., alternate gas valve 610, shown in FIG. 12, orifice member 640 is secured within valve body 612 by orifice cap 662, which is threadably received on external threads 630 on threaded end 618 of valve body 612. In the embodiment of FIG. 12, exit orifice 643 is formed in orifice cap 662 rather than formed in an exit portion 150 of orifice member 140, as shown in the embodiment of FIGS. 1-7. Orifice member 640 defines low flow orifice 654.

It should now be appreciated how simple it is to change the configuration of gas valve 10, 210, 310, 610 from a high heating value gas to a low heating value gas. All that is required is to have two separate orifice members 140, 440, 540, i.e., a first orifice member and a second orifice member. In the case of the low heating value gas, the low flow limiting orifice 154, 354, 482, 654 and exit orifice 143, 643 of orifice member 140, 440, 540, and orifice cap 662 may be sized relatively larger than the orifice corresponding to orifices 154, 354, 482, 654, and to exit orifice 143, 643 on a substitute orifice member 140, 440, 540, and orifice cap 662 for a high heating value gas.

It can also be appreciated that some distinguishing feature can be machined or stamped into some part the orifice member 140, 440, 540, 640 and orifice cap 662 to differentiate between two orifice members for two types of gas. Other means of differentiating might include but are not limited to markings, such as different colors, materials or markings.

It will now be understood how this invention uses many easy to replicate features of current valve art but adds a unique and novel feature of an orifice member 140, 440, 540, 640 that seals into the interior of rotating conical insert 60, 260, 360, 560 of a standard gas valve, thus allowing change of both high and low flow rates for different types of gas with only the replacement of the orifice member 140, 440, 540, 640 and orifice cap 662 required.

It should further be appreciated that the sealing member 160, 561 is simply a means of providing a seal which could be provided by an O-ring or by other means known to the art, including even a precision machined fit on plug end 144, 444, 544 of the orifice member 140, 440, 540, 640 into first blind hole 70, 270, 370 of the rotatable conical insert 60, 260, 360, 560. This could be accomplished by omission of the O-ring and reconfiguration of plug end 144, 444, 544 for sealing into a minimal clearance fit with the inside diameter or cylindrical surface 74, 274, 374 of first blind hole 70, 270, 370.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

1. A gas valve comprising:
a rotatable member for orienting in one of a closed position, a first flow position and a second flow position;
wherein said rotatable member blocks an input passageway in said closed position;
wherein said rotatable member permits flow into said rotatable member in said first flow position;
wherein said rotatable member permits flow around said rotatable member in said second flow position;
wherein said first flow position permits a greater flow than said second flow position.

2. The gas valve according to claim 1 wherein:
said rotatable member permits flow into and around said rotatable member in a third flow position;
wherein said third flow position permits flow that is intermediate between flow in said first flow position and said second flow position.

3. A gas valve comprising:
a rotatable member for orienting in one of a closed position, a first flow position and a second flow position;
wherein said rotatable member blocks an input passageway in said closed position;
wherein said rotatable member permits flow around said rotatable member in said first flow position;
wherein said rotatable member permits flow into said rotatable member in said second flow position;
wherein said first flow position permits a greater flow than said second flow position.

4. The gas valve according to claim 3 wherein:
said rotatable member permits flow into and around said rotatable member in a third flow position;
wherein said third flow position permits flow that is intermediate between flow in said first flow position and said second flow position.

5. A gas valve comprising:
a body that defines a cavity;
an input passageway communicating with said cavity;
a rotational member in said cavity, wherein said rotational member defines an exterior surface and an interior chamber, said rotational member defining a first port communicating said input passageway with said interior chamber, wherein said rotational member and said body define an interface therebetween;
a second passageway defined at said interface between said body and said rotational member, said second passageway having a first end and a second end;
a hollow plug member defining an exit passageway, said hollow plug member having a wall, an exit end and an inside end, said inside end received within said interior chamber of said rotational member, said exit end defining an exit orifice, said wall defining an auxiliary port that communicates an exterior of said wall of said hollow plug member with said exit passageway;
wherein said rotational member may be rotated to a first position wherein said first port establishes a gas flow path with said input passageway for allowing gas flow from said input passageway, through said first port, into said interior chamber, into said exit passageway of said hollow plug member and out of said exit orifice;
wherein said rotational member may be rotated to a second position wherein said second passageway establishes a gas flow path from said input passageway at said first end of said second passageway and with said auxiliary port for allowing flow from said input passageway, through said second passageway, through said auxiliary port, into said exit passageway of said hollow plug member and out of said exit orifice.

6. The valve according to claim 5 wherein:
said second passageway is comprised of an indentation in said rotational member.

7. The valve according to claim 5 wherein:
said second passageway is comprised of an indentation in said body.

8. The valve according to claim 5 wherein:
said second passageway is comprised of an indentation in said rotational member and of an indentation in said body.

9. The valve according to claim 5 wherein:
said rotational member defines a graded groove for metering flow into said first port.

10. The valve according to claim 5 further comprising:
a seal proximate said inside end of said hollow plug member for sealing between an outside of said hollow plug member and an inside of said interior chamber of said rotational member.

11. The valve according to claim 5 wherein:
when said rotational member is rotated to an off position, said input passageway is blocked by said exterior surface of said rotational member.

12. The valve according to claim 5 wherein:
said rotational member may be rotated to a third position wherein a gas flow path is established that allows gas flow from said input passageway through said second passageway, through said auxiliary port and into said exit passageway of said hollow plug member and out of said exit orifice; and
a third gas flow path is established through said input passageway, through a graded groove on said rotational member, into said interior chamber, and into said exit passageway of said hollow plug member and out of said exit orifice such that gas flows through said second passageway and said third gas flow path.

13. The valve according to client 12 wherein:
gas flow in said third position is intermediate between gas flow in said first position and gas flow in said second position.

14. A gas valve comprising:
a body that defines a cavity;
an input passageway communicating with said cavity;
a rotational member in said cavity, wherein said rotational member defines an exterior surface and an interior chamber, said rotational member defining a first port communicating said input passageway with said interior chamber, and a second port communicating said input passageway with said interior chamber;
a hollow plug member defining an exit passageway, said hollow plug member having a wall, an exit end and an inside end, said inside end received within said interior chamber of said rotational member, said exit end defining an exit orifice, said wall defining an auxiliary port that communicates an exterior of said wall of said hollow plug member with said exit passageway;
a seal formed between said inside end of said hollow plug member and an inside wall of said interior chamber;
wherein said rotational member may be rotated to a first position wherein said first port establishes a gas flow path with said input passageway for allowing gas flow from said input passageway, through said first port, into said interior chamber on a first side of said seal, into said exit passageway of said hollow plug member and out of said exit orifice;
wherein said rotational member may be rotated to a second position wherein said second port establishes a gas flow path with said auxiliary port for allowing flow from said input passageway, through said second port, into said interior chamber on a second side of said seal, through said auxiliary port, into said exit passageway of said hollow plug member and out said exit orifice.

15. The valve according to claim 14 wherein:
gas flow when said rotational member is in said first position is greater than gas flow when said rotational member is in said second position.

16. A method of reconfiguring a gas valve from an off position to a selected gas flow position comprising the steps of:
orienting a rotatable insert within a valve body to an off position for blocking flow from an input passageway to an output passageway with an outer surface of said rotatable insert;
rotating said rotatable insert in a first direction within said valve body from said off position to a high flow position for communicating said input passageway with a high flow orifice for directing gas flow through said high flow orifice and out an exit orifice;
rotating said rotatable insert in said first direction within said valve body from said high flow position to a low flow position for communicating said input passageway with a low flow orifice for directing gas flow through a second passageway comprised of a longitudinal slot formed in a surface of one of said rotatable insert and said valve body for directing gas flow exteriorly of a hollow plug member and through an auxiliary passageway and out said exit orifice;
wherein gas flow in said high flow position is greater than gas flow in said low flow position.

17. The method according to claim 16 wherein:
said hollow plug member is received within a cavity defined by said rotatable insert.

18. The method according to claim 16 wherein:
said rotatable insert defines an indentation that comprises said second passageway.

19. The method according to claim 16 wherein:
said valve body defines an indentation that comprises said second passageway.

20. The method according to claim 16 wherein:
said step of rotating said rotatable insert for communicating said input passageway with said high flow orifice for directing gas flow through said high flow orifice further comprises a step of selecting a rotational position of said rotatable insert to correspond to a desired depth of a graded groove on said rotatable insert for metering flow into said high flow orifice.

21. A gas valve adapted for reconfiguration from a first fuel configuration to a second fuel configuration, the gas valve comprising:
a valve body that defines a cavity;
an input passageway communicating with said cavity;
a rotational member received in said cavity, wherein said rotational member defines an exterior surface and an interior chamber, said rotational member defining a primary port for communicating said input passageway with said interior chamber, wherein said rotational member and said valve body define an interface therebetween;
a first hollow plug member defining a first exit passageway, said first hollow plug member having a wall, an exit end and a first inside end, said first inside end received within said interior chamber of said rotational member, said exit end defining a first exit orifice, said wall defining a first auxiliary port that communicates an exterior of said wall of said first hollow plug member with said first exit passageway;
a first auxiliary passageway for communicating said input passageway with said first exit passageway via said first auxiliary port;
a second hollow plug member defining a second exit passageway, said second hollow plug member having a wall, an exit end and a second inside end, said second inside end received within said interior chamber of said rotational member, said exit end defining a second exit orifice, said wall defining a second auxiliary port that communicates an exterior of said wall of said second hollow plug member with said second exit passageway;
a second auxiliary passageway for communicating said input passageway with said second exit passageway via said second auxiliary port;
wherein at least one of said first auxiliary port and said first exit orifice of said first hollow plug member is sized to receive a gas having a first heating value;
wherein at least one of said second auxiliary port and said second exit orifice of said second hollow plug member is sized to receive gas having a second heating value;
wherein one of said first hollow plug member and said second hollow plug member is affixed to said valve body for use with a gas having one of said first heating value or a second heating value;
wherein said rotational member may be rotated to an off position wherein no gas flow path is established from said input passageway to one of said first exit passageway and said second exit passageway;
wherein said rotational member may be rotated to a first position wherein a first gas flow path is established from said input passageway to one of said first exit passageway and said second exit passageway;
wherein said rotational member may be rotated to a second position wherein a second gas flow path is established from said input passageway to one of said first exit passageway and said second exit passageway.

22. The valve according to claim 21 wherein:
said first auxiliary passageway is comprised of a passageway at said interface between said body and said rotational member;
said second auxiliary passageway is comprised of a passageway at said interface between said body and said rotational member.

23. A method for reconfiguring a gas valve from a first fuel configuration to a second fuel configuration comprising the steps of:
selecting one of a first hollow plug member and a second hollow plug member wherein said first hollow plug member has ports sized for a gas having a first heating value and said second hollow plug member has ports sized for a gas having a second heating value;
inserting a selected hollow plug member into a rotational member in a valve body;
rotating said rotational member to select one of an off position, a first flow path and a second flow path.

24. The method according to claim 23 wherein:
wherein said step of rotating said rotational member to said off position results in no gas flow path being established from an input passageway to an exit passageway of the gas valve.

25. The method according to claim 23 wherein:
wherein said step of rotating said rotational member to select said first flow path results in a first gas flow path being established from an input passageway, through said rotational member, and out an exit passageway of the gas valve.

26. The method according to claim 23 wherein:
wherein said step of rotating said rotational member to select said second flow path results in a gas flow path being established from an input passageway, around said rotational member, and out an exit passageway of the gas valve.
